(19) United States
(12) Patent Application Publication
(10) Pub. No.: US 2009/0274948 A1
(43) Pub. Date: Nov. 5, 2009

(54) CORDLESS POWER TOOL BATTERY PACK SYSTEM

(76) Inventor: Samuel J. Calderone, Creve Coeur, IL (US)

Correspondence Address: HUSCH BLACKWELL SANDERS LLP, 190 CARONDELET PLAZA, SUITE 600, ST. LOUIS, MO, 63105-3441, US

(21) Appl. No.: 12/430,620

(22) Filed: Apr. 27, 2009

Related U.S. Application Data
(60) Provisional application No. 61/050,327, filed on May 5, 2008.

(51) Int. Cl. H01M 10/42; H01M 2/10

(52) U.S. Cl. 429/50; 429/99

(57) ABSTRACT

A battery pack is provided that includes a base unit, a top cover, a top circuit board, and a bottom circuit board. The base unit is disposed to retain a plurality of batteries, and the top cover is disposed to attach to the base unit to secure the plurality of batteries therein. The top circuit board and the bottom circuit board are positioned opposite each other and are secured within the base unit by the top cover. Each circuit board includes a plurality of conductors. The plurality of batteries are configured to position between the plurality of conductors of the top circuit board and the plurality of conductors of the bottom circuit board such that individual batteries of the plurality of batteries can be replaced.

### CROSS-REFERENCE TO RELATED APPLICATIONS

The present application claims the priority of provisional U.S. Patent Application Ser. No. 61/050,327 filed on May 5, 2008.

### BACKGROUND OF THE INVENTION

1. Field of the Invention

The present invention relates to cordless power tools and, more specifically, to battery packs for cordless power tools.

2. Related Art

Cordless power tools commonly use rechargeable battery packs as a power supply. Typically, as seen in FIG. 1, these battery packs include a plurality of batteries electrically coupled to provide the necessary output voltage for the power tool. The batteries are generally coupled together with a plurality of thin strips of tin-coated steel that are soldered or spot-welded between the positive and negative terminals of the batteries.

With time, the battery packs may fail because the batteries become worn down and can no longer hold a charge. However, because all of the batteries are coupled, if only one battery goes bad the overall voltage and power is reduced. When four batteries go bad within the pack, the entire pack can no longer be recharged and becomes inoperable. For example, it is common that within an inoperable battery pack, regardless of how many batteries have gone bad, the pack is typically recycled because the service centers of the store, who sells them, does not replace only the bad batteries in the pack. Specifically, because the batteries are each soldered or welded together, service centers are unable to remove and replace individual batteries. Accordingly, numerous operable batteries are unnecessarily recycled each year. This is both wasteful and uneconomical. For example, a replacement battery pack for a cordless drill may cost as much as $65. In some cases even more. Conversely, an individual battery may be replaced for less than $5.

The present invention provides a less wasteful and more economical approach to replacing inoperable battery packs. Specifically, the present invention provides a kit that eliminates the need to solder or spot-weld the batteries together. Accordingly, individual batteries within the battery pack can be replaced at a cost significantly less than replacing the entire battery pack.

### SUMMARY OF THE INVENTION

The present invention is for use in a rechargeable battery pack for a cordless power tool. The present invention also includes a kit that is used to modify an existing battery pack. The battery pack includes a base unit to retain a plurality of batteries and a top cover that attaches to the base unit to secure the plurality of batteries therein. A top circuit board and a bottom circuit board are positionable within the base unit. Each of the circuit boards includes a plurality of conductors each having a positive and negative terminal. The positive terminal includes a brass washer having an inside diameter approximately equal to an outside diameter of a battery's positive terminal to retain the battery, and the negative terminal includes a spring loaded lid to accommodate a length of the battery.

The bottom circuit board and the top circuit board are positioned within the base unit such that the negative terminals of the top circuit board are aligned with the positive terminals of the bottom circuit board and the positive terminals of the top circuit board are aligned with the negative terminals of the bottom circuit board. The plurality of batteries are positionable between the conductors of the top circuit board and the conductors of the bottom circuit board such that individual batteries can be replaced.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1(a) is an exploded view of a prior art battery pack.

FIG. 1(b) is an exploded view of an alternative prior art battery pack.

FIG. 2 is an exploded view of a modified battery pack.

FIG. 3 is an exploded view of an alternative modified battery pack.

### DETAILED DESCRIPTION OF THE PREFERRED EMBODIMENTS

The following description of the preferred embodiment(s) is merely exemplary in nature and is in no way intended to limit the invention, its application, or uses.

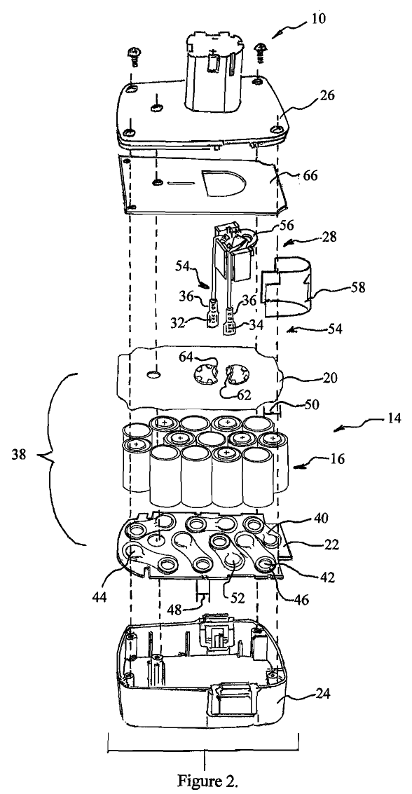

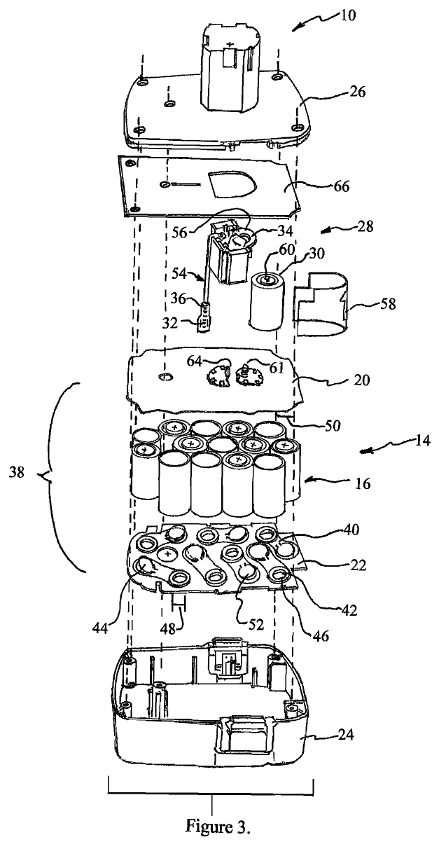

As illustrated in FIGS. 2 and 3, the present invention is a battery pack 10 for use with a cordless power tool. In the exemplary embodiment, a kit 14 is used to modify an existing battery pack 12 to form the battery pack 10 of the present invention. Specifically the kit 14 is configured to replace battery packs 12 having a plurality of batteries 16 that are spot-welded and/or soldered together with thin strips of tin-coated steel 18. The present invention provides a battery pack 10 having a top and bottom circuit board 20 and 22 that retain the batteries 16 therebetween, but also enable the replacement of a single battery 16.

The battery pack 10 includes a base unit 24 and a top cover 26. The base unit 24 and the top cover 26 are typically made from plastic, but could be manufactured from other suitable materials. The top cover 26 is configured to attach to the base unit 24 so that a plurality of batteries 16 are secured and retained within the pack 10. In the exemplary embodiment, the plurality of batteries 16 includes fourteen batteries 16; however, the battery pack 10 may be made with any suitable number of batteries 16. The batteries 16 produce a voltage capable of powering the power tool. The voltage is passed from the batteries 16 to an output terminal 28 positioned in the top cover 26. The output terminal 28 is configured to channel the voltage to the power tool. In one embodiment, the output terminal 28 also includes an extra battery 30 that provides an additional voltage to the power tool. For example, in one embodiment, the additional battery 30 provides an additional 1.2 volts to the power tool. The output terminal 28 also includes a positive 34 and negative lead 32, each having an electrical connector 36 that is configured to couple to the battery circuit 38. Specifically the leads 32 and 34 couple to top circuit board 20.

The top circuit board 20 is part of a battery circuit 38 that also includes bottom circuit board 22 and the plurality of batteries 16. In the exemplary embodiment, the circuit boards 20 and 22 are made from epoxy-glass material; however, as will be appreciated by one of skill in the art, they may be made from any material suitable for functioning as described herein. The bottom circuit board 22 is positioned opposite the top circuit board 20 so that the plurality of batteries 16 can be positioned therebetween.

The circuit boards 20 and 22 include a plurality of brass conductors 40 bonded thereto. Each of the plurality of conductors 40 includes a positive and negative terminal 42 and 44. The positive terminal 42 includes a brass washer 46 that is soldered onto the brass conductor 40. The washer 46 has an inside diameter 48 that is approximately equal to an outside diameter 50 of the positive terminal of one of the plurality of batteries 16. The washer 46 is disposed to retain the battery 16 to keep the battery 16 from moving around in the battery pack 10. The negative terminal 44 includes a spring loaded lid 52 that allows for variations in an overall length of each battery 16.

The bottom circuit board 22 and the top circuit board 20 are positioned within the battery pack 10 such that the negative terminals 44 of the top circuit board 20 are aligned with the positive terminals 42 of the bottom circuit board 22, and the positive terminals 42 of the top circuit board 20 are aligned with the negative terminals 44 of the bottom circuit board 22. Accordingly, each of the plurality of batteries 16 is operatively positioned between the top circuit board 20 and the bottom circuit board 22 such that the top circuit board 20 and the bottom circuit board 22 enable the replacement of individual batteries 16 in the battery pack 10.

In the exemplary embodiment, the top circuit board 20 and the bottom circuit board 22 are provided in a kit 14 that enables an existing battery pack 12 to be modified so that individual batteries 16 in the battery pack 12 can be replaced.

To modify the existing battery pack 12 with the kit 14, the batteries 16 must be removed from the existing pack 12 and cleaned for use in the modified pack 10. Specifically, the top cover 26 of the battery pack 12 is removed from the base unit 24 so that the batteries 16 can be separated from each other. The batteries 16 are separated by removing the metal strips 18 that have been spot-welded or soldered to the batteries 16. The voltage of each battery 16 is measured to determine which batteries 16 are spent and which are still good. The spent batteries 16 are disposed of and/or recycled and each of the good batteries 16 is cleaned by removing the spot welds to create a smooth surface that is operable with the modified battery pack 10. The spot welds are also removed from the output terminal 28.

The bottom circuit board 22 is positioned in the base unit 24. The remaining good batteries 16 and new batteries 16 to replace the spent batteries 16 are positioned between the bottom circuit board 22 and the top circuit board 20. Accordingly, the battery circuit 38 is created between the batteries 16 and the two circuit boards 20 and 22. The circuit 38 produces the power necessary to power the cordless power tool without spot-welding or soldering any of the parts. As such, an individual battery 16 of the plurality of batteries 16 can be replaced if it goes bad.

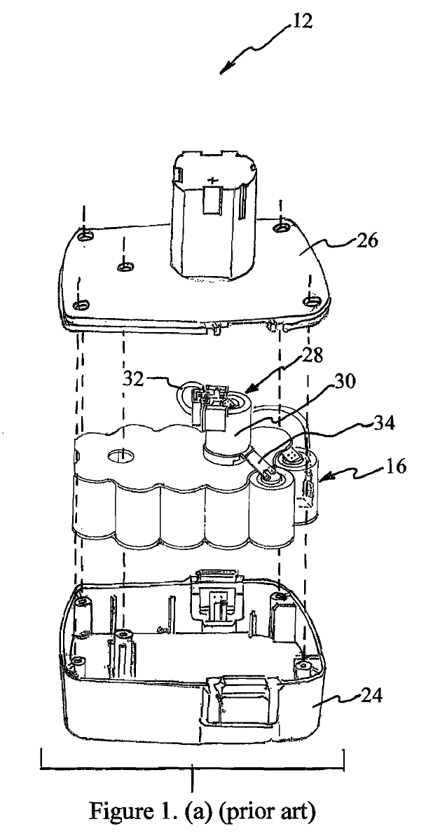

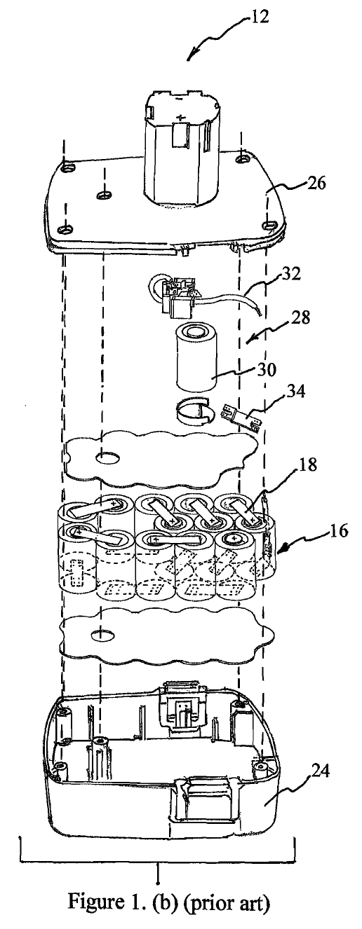

In the exemplary embodiment, FIG. 1(a) the output terminal 28 of the battery pack 12 is also modified to accommodate the top and bottom circuit boards 20 and 22. Specifically, leads 32 and 34, electrical fittings 36, and a washer 56 are added to the output terminal 28 and are coupled to the contact points 62 and 64 of the circuit board 20. The washer 56 is mounted to the positive metal contact point of the output terminal 28 and soldered into place. To help position the washer 56, a battery 30 can be positioned in the output terminal 28 and the washer 56 can be placed on the positive terminal 60 of the battery 30. This position indicates the location where washer 56 should be soldered to the positive metal contact point on the output terminal 28. In one embodiment, the battery 30 is only used as a reference point and is later removed from the output terminal 28. In another embodiment, the battery 30 is kept within the output terminal 28 to increase the output voltage and power of the battery pack 10. In one example, the extra battery 30 increases the output voltage and power of the battery pack 10 by 1.2 volts. A red lead 34 and electrical terminal 36 are then coupled to the positive metal contact point 62, and a black lead 32 and electrical terminal 36 are coupled to the negative metal contact point 64.

The modified electrical output terminal 28 is inserted in the top cover 26 and held in place with output terminal holder 58 for use in the modified battery pack 10. The circuit boards 20 and 22 are configured to fit into the battery pack 10 without making any changes to the base unit 24 and/or the top cover 26. However, in one embodiment, a foam gasket 66 is installed in the top cover 26 to more securely retain the batteries 16 and circuit boards 20 and 22 and accommodate a size of off-the-shelf batteries 16. In another embodiment, a depth of the base unit 24 is increased by approximately 0.020 inches to accommodate the size of the off-the-shelf batteries 16. Typically, the depth would be added by the manufacturer.

Next, the positive and negative electrical fittings 36 are connected to the top circuit board 20. The top cover 26 is installed on the base unit 24 to complete the modification. After modifying the battery pack 10, the output voltage of the pack 10 is checked to ensure proper connections within the pack 10 and the pack 10 is recharged.

If the pack 10 goes bad, the modifications allow the spent batteries 16 in the pack 10 to be replaced without having to waste the good batteries 16. Specifically, each battery 16 can be removed from the top and bottom circuit 20 and 22 because there are no welded connections. As such each battery 16 can be tested and replaced as needed.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An apparatus for modifying a battery pack including a plurality of individual batteries, said apparatus comprising:
a bottom circuit board;
a top circuit board;
an output terminal to electrically couple said bottom circuit board and said top circuit board to a tool operated by the battery pack;
each of said bottom circuit board and said top circuit board comprising a plurality of conductors, at least one of said conductors comprising a positive terminal and at least one of said conductors comprising a negative terminal;
said bottom circuit board and said top circuit board configured to position within the battery pack such that said negative terminals of said top circuit board are aligned with said positive terminals of said bottom circuit board, and said positive terminals of said top circuit board are aligned with said negative terminals of said bottom circuit board; and
said top circuit board and said bottom circuit board configured to allow replacement of one or more of said individual batteries when one of said top and bottom circuit boards is removed from said individual batteries.

2. The apparatus according to claim 1, wherein said positive terminals comprise a metal washer configured to engage a positive terminal of a battery.

3. The apparatus according to claim 1, wherein said negative terminals comprise a spring-loaded lid configured to engage a negative terminal of a battery.

4. The apparatus according to claim 1 further comprising a gasket positioned on the top circuit board to secure the individual batteries in the battery pack.

5. The apparatus according to claim 1, wherein said output terminal comprises a flexible battery holder capable of holding an additional battery.

6. The apparatus according to claim 1, wherein the individual batteries are positioned between said top circuit board and said bottom circuit board without welding and soldering to enable the replacement of the individual batteries in the battery pack.

7. The apparatus according to claim 1, wherein said top circuit board and said bottom circuit board comprise an epoxy-glass material.

8. A method of modifying a battery pack, wherein the battery pack includes a base unit, a top cover coupled to the base unit, and a plurality of batteries secured within the base unit and coupled together, said method comprising the steps of:
decoupling the plurality of batteries;
positioning a bottom circuit board within the base unit;
positioning the plurality of batteries on the bottom circuit board;
positioning a top circuit board on the plurality of batteries, such that an individual battery of the plurality of batteries can be replaced;
positioning an output terminal in communication with the top circuit board; and
securing the top cover to the base unit to secure the plurality of batteries therein.

9. The method according to claim 8, wherein decoupling the plurality of batteries further comprises removing existing electrical strips from the plurality of batteries.

10. The method according to claim 9 further comprising removing spot-welds from the plurality of batteries after removing the existing electrical strips.

11. The method according to claim 8 further comprising:
testing the plurality of batteries; and
discarding and replacing spent batteries prior to positioning the plurality of batteries on the bottom circuit board.

12. The method according to claim 8 further comprising positioning a gasket on the top circuit board to secure the plurality of batteries in the battery pack.

13. The method according to claim 8, wherein positioning the plurality of batteries further comprises positioning the plurality of batteries without welding and soldering.

14. A battery pack comprising:
a plurality of batteries;
a base unit disposed to retain said plurality of batteries;
a top cover disposed to attach to said base unit to secure the plurality of batteries in said base unit;
a top circuit board comprising a plurality of conductors;
a bottom circuit board comprising a plurality of conductors and positioned opposite said top circuit board, said top circuit board and said bottom circuit board secured within said base unit by said top cover; and
an output terminal to electrically couple said bottom circuit board and said top circuit board to a tool operated by said battery pack,
the plurality of batteries configured to position between said plurality of conductors of said top circuit board and said plurality of conductors of said bottom circuit board such that one or more individual batteries of said plurality of batteries can be replaced.

15. A battery pack according to claim 14 wherein said at least on of said plurality of conductors comprises a positive terminal and at least one of said plurality of conductors comprises a negative terminal, said negative terminals of said top circuit board aligned with said positive terminals of said bottom circuit board, and said positive terminals of said top circuit board aligned with said negative terminals of said bottom circuit board.

16. The battery pack according to claim 15, wherein said positive terminals comprise a metal washer configured to engage a positive terminal of a battery.

17. The battery pack according to claim 15, wherein said negative terminals comprise a spring-loaded lid configured to engage a negative terminal of a battery.

18. The battery pack according to claim 14 further comprising a gasket positioned on the top circuit board to secure the individual batteries in the battery pack.

19. The battery pack according to claim 14, wherein said output terminal comprises an additional individual battery.

20. The battery pack according to claim 14, wherein the individual batteries are positioned between said top circuit board and said bottom circuit board without welding and soldering to enable the replacement of the individual batteries in the battery pack.

21. The battery pack according to claim 14, further comprising an output terminal holder to position said output terminal into said top cover.
